(19) United States
(12) Patent Application Publication
(10) Pub. No.: US 2009/0167742 A1
(43) Pub. Date: Jul. 2, 2009

(54) Display Device Driving Circuit, Data Signal Line Driving Circuit, and Display Device

(76) Inventors: Yousuke Nakagawa, Taki-gun Mie (JP); Shinsaku Shimizu, Jiangsu Province (CN); Tamotsu Sakai, Ikoma-shi Nara (JP)

Correspondence Address: HARNESS, DICKEY & PIERCE, P.L.C., P.O. BOX 8910, RESTON, VA, 20195, US

(21) Appl. No.: 12/226,031

(22) PCT Filed: Feb. 28, 2007
(86) PCT No.: PCT/JP2007/053715

§ 371 Date: Oct. 6, 2008

(30) Foreign Application Priority Data
May 24, 2006 (JP) 2006-144715

(51) Int. Cl. G09G 5/00; G09G 3/36

(52) U.S. Cl. 345/211; 345/87

(57) ABSTRACT

In one embodiment of the present invention, a driving circuit is disclosed of a display device, a connection and disconnection section is provided between an output of an analog amplifier circuit and an input of a digital circuit. The connection and disconnection section breaks an electrical connection between the output of the analog amplifier circuit and the input of the digital circuit until an output voltage of the analog amplifier circuit rises to a target DC level, and makes an electrical connection between the output of the analog amplifier circuit and the input of the digital circuit after the output voltage of the analog amplifier circuit has risen to the target DC level.

### TECHNICAL FIELD

The present invention relates to a circuit configuration for use in a driving circuit for a display device, in which driving circuit an analog circuit is followed by a digital circuit.

### BACKGROUND ART

Liquid crystal display devices have been manufactured in which a driving circuit for a liquid crystal panel and the liquid crystal panel are monolithically formed by use of a polysilicon. A polysilicon thin film transistor has a higher threshold voltage than a transistor which uses a single-crystal silicon. Therefore, liquid crystal panels which use the polysilicon, generally, drives the polysilicon thin film transistor after carrying out a level shift with respect to a signal voltage to be supplied to the driving circuit.

Patent Document 1 discloses a liquid crystal display device which carries out such a level shift. A liquid crystal display device illustrated in FIG. 11 is introduced in Patent Document 1 as a well-known technique.

In the liquid crystal display device illustrated in FIG. 11, a clock signal cks and a start signal sps are supplied from outside of a data signal line driving circuit SD. A level shifter LS steps up the voltages of the clock signal cks and the start signal sps from 5 V to 15 V, and then supplies them to a shift register circuit 105. This causes latch circuits SR in the shift register circuit 105 to sequentially output signals n1, n2, . . . , respectively. The signals n1, n2, . . . are converted into control signals of sampling circuits (analog switch) AS, respectively, via circuits such as a NAND circuit and an inverter(s). The control signals cause the sampling circuits AS (i) to sample data dat to be supplied to the data line signal driving circuit SD, and (ii) to supply the data dat to data signal lines SL1, SL2, . . . in a dot sequential manner.

Patent Document 1 discloses a scanning signal line driving circuit GD illustrated in FIG. 12. In the scanning signal line driving circuit GD illustrated in FIG. 12, (i) a level shifter circuit LS1 steps up externally supplied start signals spg and /spg from 5 V to 16 V, respectively, and then supplies them to latch circuits LS-SR in a shift register circuit 128, and (ii) a level shifter circuit LS2 steps up externally supplied pulse width control signals gps and /gps from 5 V to 16 V, and then supplies them to logic circuits of NOR circuits 130, 131, . . . in the scanning signal line driving circuit GD. In the scanning signal line driving circuit GD, output signals/n1, /n2, . . . of the latch circuits LS-SR are converted to scan signals gl1, gl2, . . . , via the logic circuits, and are then supplied to scan signal lines GL1, GL2, . . . , respectively.

### [Patent Document 1]

Japanese Unexamined Patent Publication, Tokukai, No. 2000-187461 (published Jul. 4, 2000).

### DISCLOSURE OF INVENTION

However, the following problems occur in the conventional liquid crystal display device.

In the arrangements illustrated in FIGS. 11 and 12, a digital circuit which receives an output signal of an analog level shifter circuit has a CMOS logic structure. A round output voltage of the level shifter circuit would not sharply rise or fall. As such, if the round output voltage of the level shifter circuit slowly reaches an ultimate value, then both of p-channel and n-channel MOS transistors of a stage, to which the output voltage is supplied, concurrently turn on for a long period of time. This causes a large through current to flow. More specifically, as illustrated in FIG. 13, when a digital circuit by which the level shifter circuit is followed includes a circuit configuration equivalent to a CMOS inverter made up of a p-channel MOS transistor 151 and an n-channel MOS transistor 152 which concurrently receive the output voltage of the level shifter circuit, both transistors concurrently turn on for a long time in response to a slowly changing input voltage supplied from the level shifter circuit. Accordingly, a large through current flows from a power source VDD towards a power source VSS.

In such a case, a large through current also flows even if a slowly changing voltage is supplied in a state where another MOS transistor(s), provided between the power source VDD and the MOS transistor 151 and/or between the power source VSS and the MOS transistor 152, turn(s) on. Therefore, even with the arrangements illustrated in FIGS. 11 and 12, when a circuit configuration equivalent to the CMOS inverter is included in a stage, to which an output voltage of the level shifter circuit is supplied, a large through current flows.

A problem occurs that the driving circuit of the liquid crystal display device has great electric power consumption, thus caused by the through current flowing in the digital circuit.

In view of this, the inventors study a relationship between an amplitude of the input voltage of the level shifter circuit and a rise time or a fall time of the output voltage.

A level shifter circuit 200 illustrated in FIG. 14 is a so-called 6-transistor level shifter circuit, which uses six MOS transistors.

The level shifter circuit 200 includes p-channel MOS transistors 201 through 204, and n-channel MOS transistors 205 and 206. A source of the MOS transistor 201 is connected to a power source VDD, and a drain of the MOS transistor 201 is connected to a source of the MOS transistor 203. A gate of the MOS transistor 201 is connected to an output terminal OUT of the level shifter circuit 200. The output terminal OUT is a node point connecting a drain of the MOS transistor 204 with a drain of the MOS transistor 206. A source of the MOS transistor 202 is connected to the power source VDD, and a drain of the MOS transistor 202 is connected to a source of the MOS transistor 204. A gate of the MOS transistor 202 is connected to an inverted output terminal OUTB of the level shifter circuit 200. The inverted output terminal OUTB is a node point connecting a drain of the MOS transistor 203 with a drain of the MOS transistor 205.

A source of the MOS transistor 205 and a source of the MOS transistor 206 are connected to a power source VSS. A gate of the MOS transistor 203 and a gate of the MOS transistor 205 are connected to each other, and a node point connecting the two gates serves as an input terminal IN of the level shifter circuit 200. A gate of the MOS transistor 204 and a gate of the MOS transistor 206 are connected to each other, and a node point connecting the two gates serves as an inverted input terminal INB of the level shifter circuit 200.

Next, on the condition that voltages of the power source VDD and the power source VSS are set to 3 V and 0 V, respectively, and respective wiring of the input terminal IN and the inverted input terminal INB are set to have a resistance of 1 kΩ and a parasitic capacitance of 10 pF, in the above-arranged level shifter circuit 200 as illustrated in FIG. 15(a), a simulation was carried out and it was confirmed how the output voltage of the output terminal OUT changes in its rise time (the time required for an output voltage to reach from 10% to 90% of the maximum output voltage), when an amplitude of an input voltage of a square wave signal is changed.

Four patterns of input voltages are provided, as illustrated in FIG. 15(b): (1) a voltage having an amplitude of 2 V, i.e., a High level of 2 V and a Low level of 0 V; (2) a voltage having an amplitude of 1.7 V, i.e., a High level of 2 V and a Low level of 0.3 V; (3) a voltage having an amplitude of 1.4 V, i.e., a High level of 2 V and a Low level of 0.6 V; and (4) a voltage having an amplitude of 1.1 V, i.e., a High level of 2 V and a Low level of 0.9 V. The level shifter circuit 200 converts each of the input voltages into and outputs a voltage having 0 V/3 V amplitude. Rise characteristics of output voltages outputted via the output terminal OUT and the inverted output terminal OUTB change depending on loads to be connected to the output terminal OUT and the inverted output terminal OUTB, respectively. The loads were set to a gate capacitor of the CMOS circuit, in view of the fact that the output voltage of the level shifter circuit 200 is supplied to a configuration equivalent to the CMOS inverter.

The output voltages had rise time of 19.2 ns, 25.15 ns, 38.13 ns, and 76.7 ns for the above (1) through (4), respectively. A curved line as shown in FIG. 15(c) is achieved by plotting these results.

As is clear from the above, the rise time becomes longer as the amplitude of an input voltage is smaller. This can be understood as follows. More specifically, when an input voltage has a small amplitude, for example when a High voltage is supplied via an input terminal IN and a Low voltage is supplied via an inverted input terminal INB, a gate voltage (=a voltage across gate and source) of an n-channel MOS transistor 205 is 2 V. This 2 V is not different than a large amplitude but a gate voltage (=a voltage across gate and source) of a p-channel MOS transistor 204 decreases. Therefore, a drain current of the p-channel MOS transistor 204 is suppressed small. This causes an increase in time required for the drain current to charge a capacitor load connected to the output terminal OUT, thereby resulting in that the voltage outputted via the output terminal OUT slowly rises.

The level shifter circuit 200 carries out operation so that the output electrode has an amplitude of 3 V. Thus, in the level shifter circuit 200, the smaller an input voltage is, the larger gain of output signal/input signal the level shifter circuit 200 attains. Therefore, it is possible to say that a larger gain causes a slower rise in the output voltage.

The level shifter circuits are thus a non-linear amplifier whose gain differs from input voltages having various amplitudes. The level shifter circuit outputs a DC (direct current) level so as to increase the amplitude of an input voltage of a square wave.

Even a linear differential amplifier circuit, which can be used as a direct current amplifier, has a finite slew rate when a DC level is outputted. As such, a rise time or a fall time of an output voltage causes a problem. Furthermore, a comparator has a similar problem.

As is clear from the above study, an analog amplifier circuit readily outputs a voltage having a slow rise, in a case where a digital circuit, having a CMOS circuitry, by which the analog amplifier circuit is followed, receives the output voltage of the analog amplifier circuit which outputs a DC level in accordance with an input. Therefore, there is the problem of causing an increase in electric power consumption since a through current readily flows through the CMOS circuitry.

The present invention is made in view of the problems, and its object is to realize a driving circuit for a display device difficult for a through current to flow through a CMOS circuitry, even if a driving circuit, by which the analog amplifier circuit which outputs a DC level in accordance with an input signal is followed, includes a CMOS circuitry, to which circuitry an output voltage is supplied from the analog amplifier circuit. Another object is to realize a data signal line driving circuit as such a driving device in a display device, and a display device including such a driving circuit.

In order to attain the objects, a driving circuit of the present invention for a display device includes a circuit configuration including (i) an analog amplifier circuit which outputs a DC level in accordance with an input signal and (ii) a digital circuit, by which the analog amplifier circuit is followed, including a CMOS circuitry, to which circuitry an output voltage is supplied from the analog amplifier circuit, said driving circuit using an output signal supplied from the digital circuit in display driving, the driving circuit, further including: connection and disconnection means for making and breaking an electrical connection between an output of the analog amplifier circuit and an input of the CMOS circuitry.

According to the invention, a driving circuit of a display device includes connection and disconnection means. Therefore, when a voltage, having a DC level which varies in accordance with an input signal, is outputted as an output voltage from the analog amplifier circuit, it is possible for the connection and disconnection means to (i) break an electrical connection between an output of the analog amplifier circuit and an input of a digital circuit until the output voltage rises or falls to a target DC level, and (ii) make the electrical connection between the output of the analog amplifier circuit and the input of the digital circuit after the output voltage has risen or fallen to the target DC level. This allows the DC level which has risen or fallen to be supplied, as the output voltage of the analog amplifier circuit, to a CMOS circuitry included in the digital circuit. It follows that no output voltage during a rise period or a fall period of the analog amplifier circuit is supplied to the CMOS circuitry. Therefore, it is possible to suppress a through current occurring in the CMOS circuitry.

As described above, even if a digital circuit, by which the analog amplifier circuit which outputs a DC level in accordance with an input signal is followed, includes a CMOS circuitry, to which an output voltage is supplied from the analog amplifier circuit, it is possible to realize a driving circuit of a display device difficult for a through current to flow in the circuit having the CMOS circuitry.

For a fuller understanding of the nature and advantages of the invention, reference should be made to the ensuing detailed description taken in conjunction with the accompanying drawings.

### BRIEF DESCRIPTION OF DRAWINGS

FIG. 1 illustrates one embodiment of the present invention, and is a block diagram illustrating a circuit configuration in a driving circuit of a display device of a section in which a digital circuit is provided following an analog amplifier circuit.

FIG. 2 is a waveform chart of a signal describing an operation of the arrangement shown in FIG. 1.

FIG. 3 is a circuit diagram schematically illustrating a conceptual first configuration example of a connection and disconnection section in the circuit configuration shown in FIG. 1.

FIGS. 4(a) through 4(c) are circuit diagrams specifically illustrating the circuit configuration shown in FIG. 3.

FIG. 5 is a circuit diagram schematically illustrating a conceptual second configuration example of a connection and disconnection section in the circuit configuration shown in FIG. 1.

FIGS. 6(a) and 6(b) are circuit diagrams specifically illustrating the circuit configuration shown in FIG. 5, and FIG. 6(c) is a truth table of the circuits shown in (a) and (b).

FIG. 7 illustrates one embodiment of the present invention, and is a block diagram illustrating an arrangement of a display device.

FIG. 8 is a circuit diagram illustrating a pixel configuration of the display device as shown in FIG. 7.

FIG. 9 is a block diagram illustrating a circuit configuration of a data signal line driving circuit included in the display device as shown in FIG. 7.

FIG. 10 is a circuit diagram which applies the circuit configuration shown in FIG. 1 in a data signal line driving circuit.

FIG. 11 illustrates a conventional technique, and is a circuit block diagram illustrating a circuit configuration of a data signal line driving circuit of a liquid crystal display device.

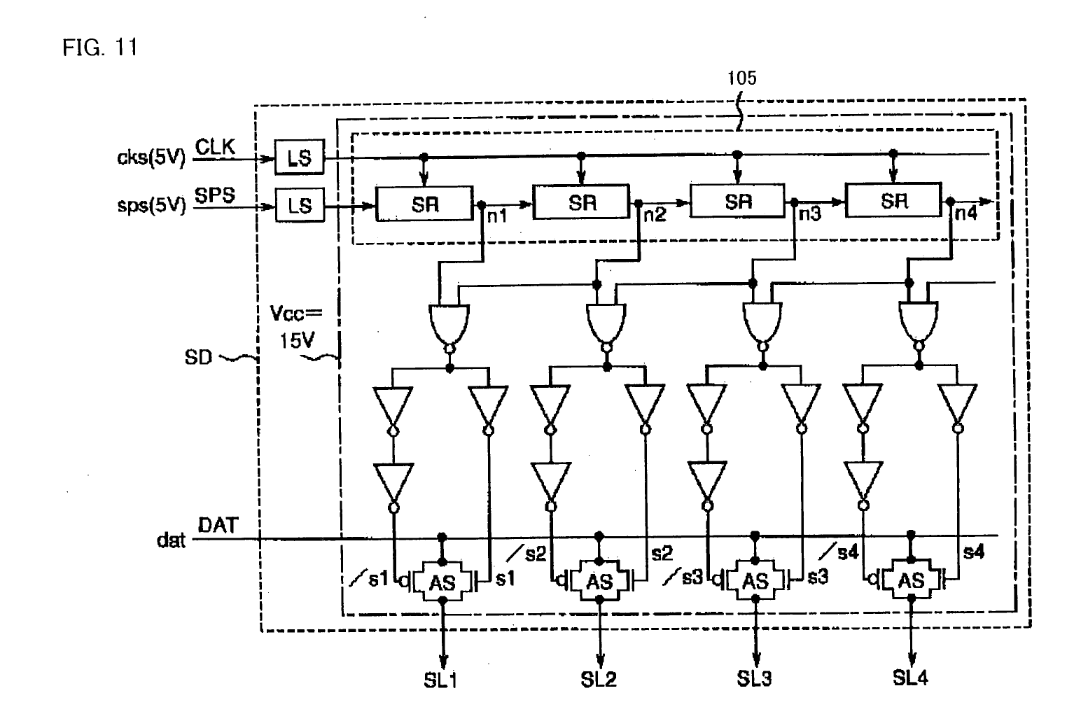

FIG. 12 illustrates a conventional technique, and is a circuit block diagram illustrating a circuit configuration of a scanning signal line driving circuit of a liquid crystal display device.

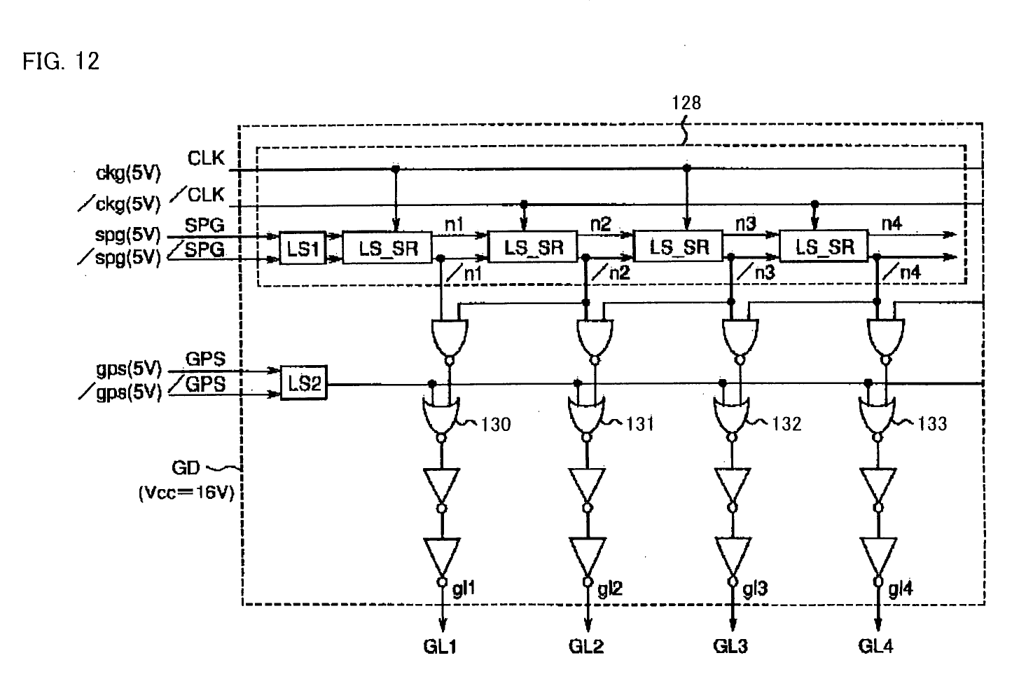

FIG. 13 is a circuit diagram illustrating a circuit configuration of an inverter.

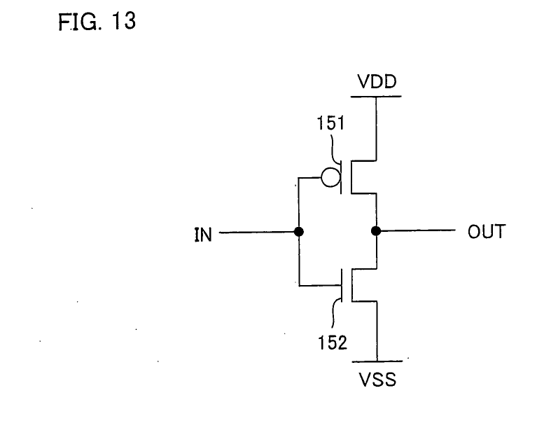

FIG. 14 is a circuit diagram illustrating a circuit configuration example of a level shifter circuit.

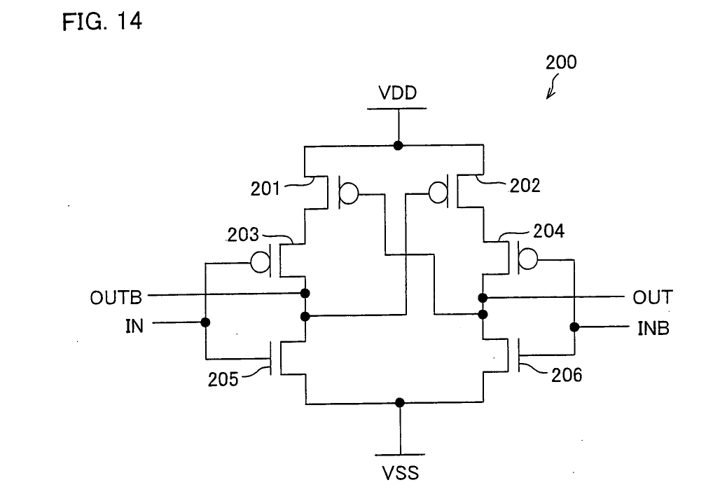

FIGS. 15(a) through 15(c) are explanatory drawings illustrating a simulation carried out to confirm how an output voltage rises in a level shifter circuit.

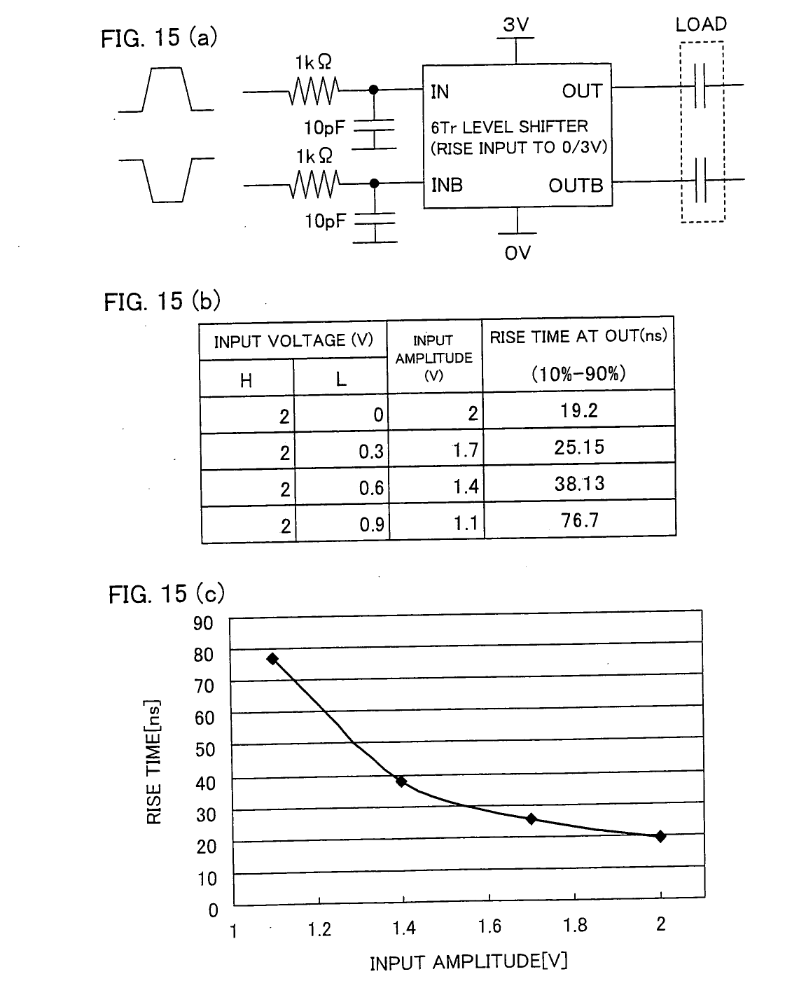

FIG. 16(a) illustrates one embodiment of the present invention, and is a block diagram schematically illustrating a circuit configuration in a driving circuit of a display device of a section in which a digital circuit is provided, by which an analog amplifier circuit is followed, and FIG. 16(b) is an explanatory drawing illustrating a correspondence relationship of an input and an output of a digital circuit included in the circuit configuration shown in FIG. 16(a).

### REFERENCE NUMERALS

1 Analog amplifier circuit
2 Digital circuit
3 Connection and disconnection section (connection and disconnection means)
11 Level shifter circuit (analog amplifier circuit)
21 Inverter (digital circuit)
310b Switch (logic inputting means)
320d MOS transistor (logic inputting means)

### BEST MODE FOR CARRYING OUT THE INVENTION

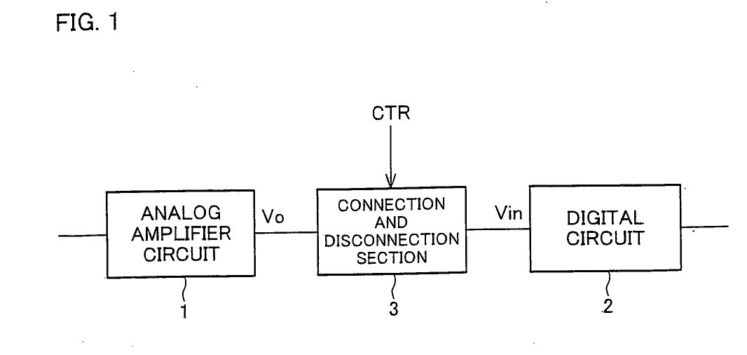

One embodiment of the present invention is described below with reference to FIGS. 1 through 10.

In the BACKGROUND ART, it is explained that data signal line driving circuits and scanning signal driving circuits of liquid crystal display devices include various circuit configurations in which a digital circuit, including a CMOS circuitry, by which an analog amplifier circuit is followed. In this circuit configuration, the analog amplifier circuit outputs a DC level in accordance with an input signal, and the CMOS circuitry included in the digital circuit receives an output voltage of the analog amplifier circuit. Instead, the present embodiment provides a circuit configuration as shown in FIG. 1.

FIG. 1 illustrates a circuit configuration in which a connection and disconnection section (connection and disconnection means) 3 is provided between (a) an output terminal of an analog amplifier circuit 1 in which a DC level which varies in accordance with an input signal is outputted and (b) an input terminal of a digital circuit 2 which includes a circuit of a CMOS circuit configuration, to which circuit an output voltage of the analog amplifier circuit 1 is supplied from the analog amplifier circuit 1. The connection and disconnection section 3 receives a control signal CTR generated inside or outside the driving circuit.

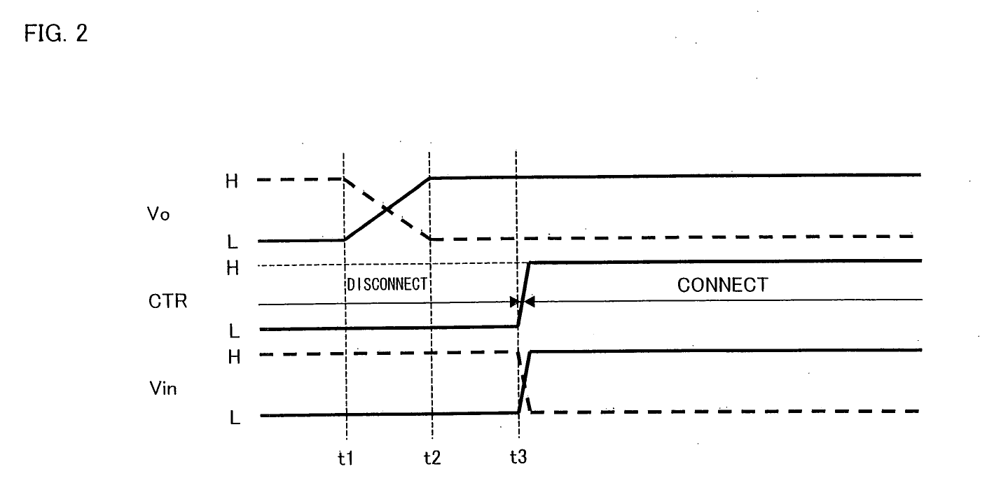

FIG. 2 shows respective waveform of (i) an output voltage Vo of the analog amplifier circuit 1, (ii) the control signal CTR, and (iii) an input voltage Vin of the digital circuit 2.

Assume that the output voltage Vo of the analog amplifier circuit 1 has a Low DC level until time t1, and the DC level starts to rise from a Low level to a High DC level at time t1. Meanwhile, the control signal CTR to be supplied to the connection and disconnection section 3 is a Low level. This causes the connection and disconnection section 3 to break an electrical connection between the output terminal of the analog amplifier circuit 1 and the input terminal of the digital circuit 2. Assume that the output voltage Vo of the analog amplifier circuit 1 completely rises at time t2, and then the output voltage Vo is stabilized so as to have a DC level which is in accordance with an input signal of the analog amplifier circuit 1. A rise period of the output voltage Vo indicates a time period in which the output voltage Vo changes its level from a level higher, by 10% of a difference, than a stable DC level until the time t1 to a level higher, by 90% of the difference, than the stable DC level until the time t1. The difference indicates a difference between the stable DC level of the output voltage Vo of the analog amplifier circuit 1 until the time t1 and a stable DC level of the output voltage of the analog amplifier circuit 1 on or after the time t2. Therefore, this intends to mean that a rise starts at the time when the level becomes higher by the above 10% and a rise ends at the time when the level becomes higher by the above 90%.

After the time t2, the control signal CTR switches from a Low level to a High level at a time t3. This causes the connection and disconnection section 3 to connect an electrical connection between the output terminal of the analog amplifier circuit and the input terminal of the digital circuit 2. Until t3, the digital circuit 3 receives a Low level voltage from a different route. This prevents indefinite input logic while the connection and disconnection section 3 is carrying out breaking of the electrical connection. The connection between the output terminal of the analog amplifier circuit 1 and the input terminal of the digital circuit 2 allows the digital circuit 3 to receive a DC level of the output voltage Vo of the analog amplifier circuit 1. At the same time, an input of the voltage received by the digital circuit 2 from the different route is blocked. Therefore, the output voltage Vo of the analog amplifier circuit 1 which has risen is supplied to the digital circuit 2.

The above voltage waveform deals with a case where (i) the output voltage Vo of the analog amplifier circuit 1 rises from a Low DC level to a High DC level, and (ii) the input voltage Vin changes from a Low DC level to a High DC level. However, this is only one example. The present embodiment may include a case where the output voltage Vo of the analog amplifier circuit 1 falls from a High DC level to a Low DC level, and the input voltage Vin of the digital circuit 2 changes from a High DC level to a Low DC level. In such case, a fall period of the output voltage Vo indicates a time period in which the output voltage Vo changes its level from a level lower, by 10% of a difference, than a stable DC level until the time t1 to a level lower, by 90% of the difference, than the stable DC level until the time t1. The difference indicates a difference between the stable DC level of the output voltage Vo of the analog amplifier circuit 1 until the time t1 and a stable DC level of the output voltage of the analog amplifier circuit 1 on or after the time t2. Therefore, this intends to mean that a fall starts at the time when the level becomes lower by the above 10% and a fall ends at the time when the level becomes lower by the above 90%. A logic of the control signal CTR may also be an inverted one of the waveform shown in FIG. 2.

In order for the control signal CTR to change from a Low DC level to a High DC level, or vice versa, at the above timing, a rise period or a fall period of the output voltage Vo of the analog amplifier circuit 1 should be checked in advance, and the control signal CTR should be generated in accordance with the rise period or the fall period thus checked.

As described above, a driving circuit for a display device in accordance with the present embodiment includes a connection and disconnection section 3. Therefore, when a DC level is outputted from the analog amplifier circuit 1 as the output voltage Vo, it is possible for the connection and disconnection section 3 to (i) break an electrical connection between the output terminal of the analog amplifier circuit 1 and the input terminal of the digital circuit 2 until the output voltage Vo rises or falls to a target DC level, and (ii) make an electrical connection between the output terminal of the analog amplifier circuit 1 and the input terminal of the digital circuit 2 after the output voltage Vo has risen or fallen to the target DC level. This allows the CMOS circuitry in the digital circuit 2 to receive from the analog amplifier circuit 1 an output voltage Vo, having a DC level, which has risen or fallen. It follows that no output voltage Vo generated during a rise period or a fall period of the analog amplifier circuit 1 is supplied to the CMOS circuitry. This causes suppression of generation of a through current in the CMOS circuit.

As described above, even if a digital circuit, by which the analog amplifier circuit is followed, includes a CMOS circuitry, to which an output voltage is supplied from the analog amplifier circuit, it is possible to realize a driving circuit of a display device difficult for a through current to flow in the circuit having the CMOS circuit.

The following description deals with a more specific arrangement of the connection and disconnection section 3.

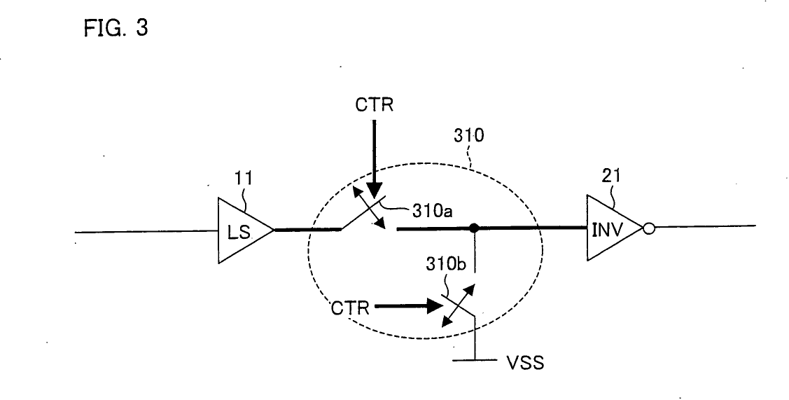

FIG. 3 schematically illustrates a connection and disconnection section 310, as a conceptual first example of the connection and disconnection section 3. The connection and disconnection section 310 is made up of switches 310a and 310b. In FIG. 3, a level shifter 11 serves as the analog amplifier circuit 1, and an inverter 21 having a CMOS circuit configuration serves as the digital circuit 2. The switch 310a breaks or makes a path between an output terminal of the level shifter circuit 11 and an input terminal of the inverter 21. The switch 310b breaks or makes a path between the input terminal of the inverter 21 and a power source VSS of a predetermined electric potential. The predetermined electric potential is a power source causing a predetermined logic to be supplied to the digital circuit 2 so that an input logic of the digital circuit 2 is not indefinite while the connection and disconnection section 3 breaks the electrical connection between the output terminal of the analog amplifier circuit 1 and the input terminal of the digital circuit 2, as explained with reference to FIGS. 1 and 2. Namely, the switch 310b functions as logic inputting means.

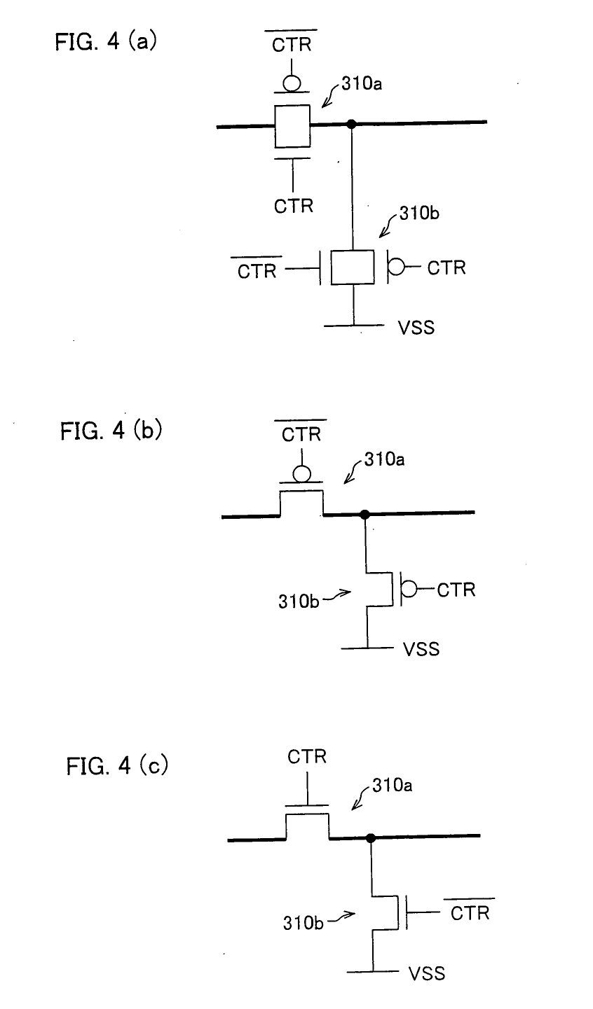

FIGS. 4(a) through 4(c) illustrate specific configurations of the switches 310a and 310b. In the present embodiment, the logic of a control signal CTR is assumed to be the same as in FIG. 2.

FIG. 4(a) is an example of a circuit configuration in which the switches 310a and 310b are realized by CMOS analog switches, respectively. In the switch 310a, a control signal CTR is supplied to a gate of an n-channel MOS transistor, and a control signal/CTR, which is an inverted signal of the control signal CTR, is supplied to a gate of a p-channel MOS transistor. In the switch 310b, the control signal /CTR is supplied to a gate of an n-channel MOS transistor, and the control signal CTR is supplied to a gate of a p-channel MOS transistor.

FIG. 4(b) is an example of a circuit configuration in which the switches 310a and 310b are realized by PMOS analog switches, respectively. The control signal /CTR is supplied to a gate of (a p-channel MOS transistor) the switch 310a, and the control signal CTR is supplied to a gate of (a p-channel MOS transistor) the switch 310b.

FIG. 4(c) is an example of a circuit configuration in which the switches 310a and 310b are realized by NMOS analog switches, respectively. The control signal CTR is supplied to a gate of (an n-channel MOS transistor) the switch 310a, and the control signal /CTR is supplied to a gate of (an n-channel MOS transistor) the switch 310b.

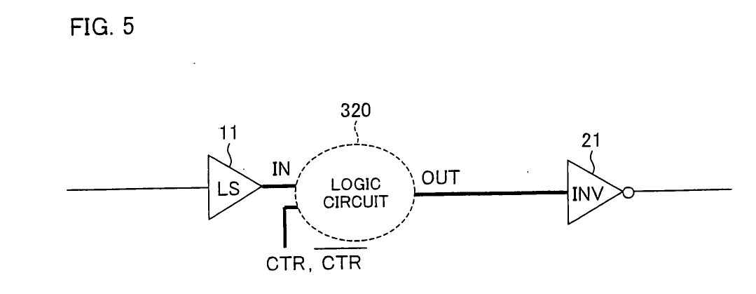

FIG. 5 illustrates a connection and disconnection section 320 as a second conceptual arrangement example of the connection and disconnection section 3. The connection and disconnection section 320 is made up of a logic circuit. A level shifter circuit 11 serves as the analog amplifier circuit 1, and an inverter 21 having a CMOS circuit configuration serves as the digital circuit 2. The logic circuit 320 generates an output signal OUT based on a combination of (i) an input signal IN which is an output signal of the level shifter circuit 11 and (ii) control signals CTR and /CTR. The output signal OUT is then supplied to the inverter 21.

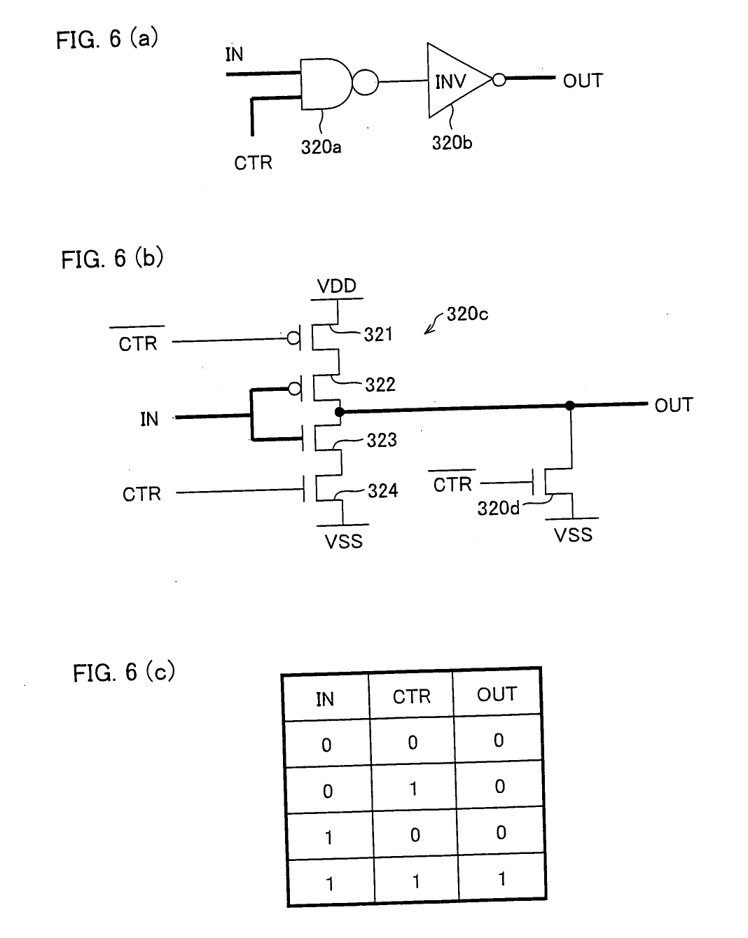

FIGS. 6(a) and 6(b) illustrate a specific configuration of the connection and disconnection section 320. Logic of the control signal CTR is assumed to be the same as FIG. 2.

FIG. 6(a) illustrates an example in which the connection and disconnection section 320 is made up of a NAND circuit 320a and an inverter 320b. The NAND circuit 320a receives an input signal IN and a control signal CTR. The inverter 320b receives, logically inverts, and outputs an output signal of the NAND circuit 320a as an output signal OUT of the connection and disconnection section 320.

FIG. 6(b) illustrates an example in which the connection and disconnection section 320 is made up of a clocked inverter 320c and an n-channel MOS transistor 320d. The clocked inverter 320c includes (i) a CMOS inverter including a p-channel MOS transistor 322 and an n-channel MOS transistor 323, (ii) a p-channel MOS transistor 321 provided on a power source VDD side of the CMOS inverter, and (iii) an n-channel MOS transistor 324 provided on a power source VSS side of the CMOS inverter. A control signal /CTR is supplied to a gate of the MOS transistor 321, and a control signal CTR is supplied to a gate of the MOS transistor 324. The MOS transistor 320d is connected so as to be provided between (i) the power source VSS and (ii) a node point, connecting the MOS transistor 322 with the MOS transistor 323, which serves as an output terminal of the clocked inverter 320c. A control signal /CTR is supplied to a gate of the MOS transistor 320d. A node point connecting the output terminal of the clocked inverter 320c with a drain of the MOS transistor 320d serves as a terminal via which the connection and disconnection section 320 outputs an output signal OUT.

The circuit configurations of FIGS. 6(a) and 6(b) have a relationship of (i) the input signal IN, (ii) the control signal CTR and (iii) the output signal OUT as shown in a truth table in FIG. 6(c). Note that logic inputting means shown in FIG. 6(a) is included in the NAND circuit 32a and the inverter 32b. Logic inputting means shown in FIG. 6(b) is the MOS transistor 320d.

The following description deals with a data signal line driving circuit of a liquid crystal display device in which the concept of the present embodiment is suitably used.

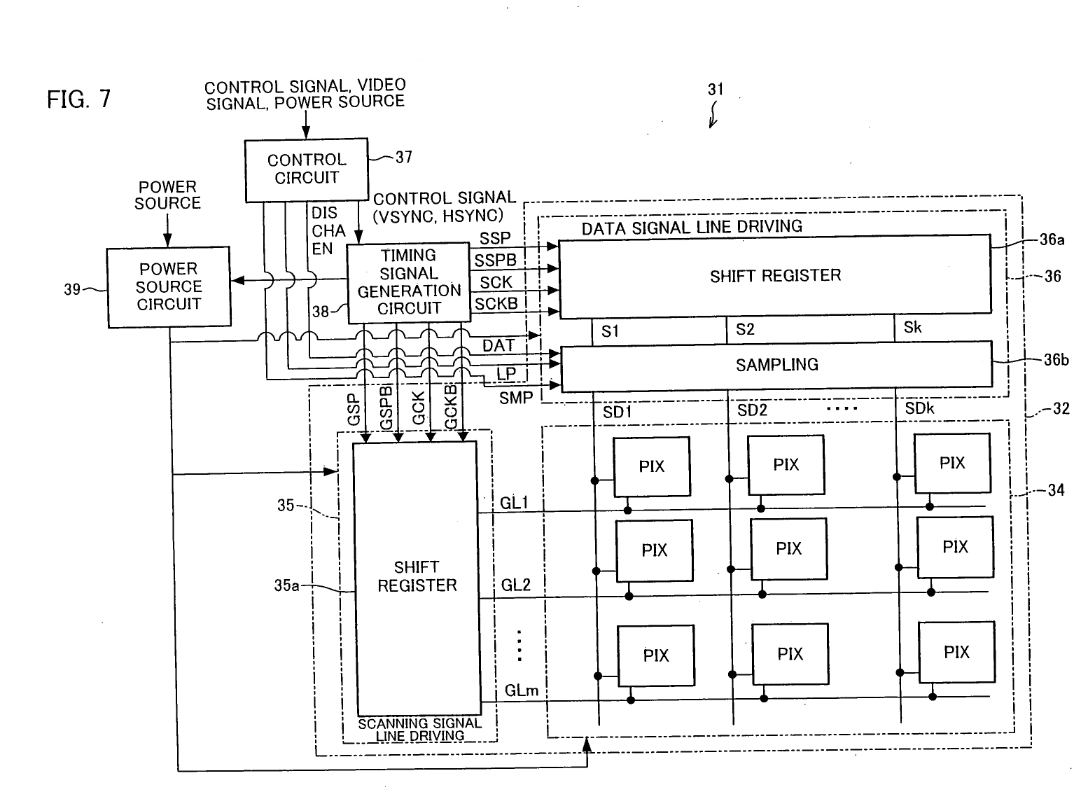

FIG. 7 is a block diagram of a liquid crystal display device 31. The liquid crystal display device 31 is basically arranged to include a display panel 32, a control circuit 37, a timing signal generation circuit 38, and a power source circuit 39. The display panel 32 is arranged to include a display section 34 which has pixels PIX aligned in a matrix manner, a scanning signal line driving circuit 35, and a data signal line driving circuit 36. The scanning signal line driving circuit 35 and the data signal line driving circuit 36 drive the pixels PIX. The scanning signal line driving circuit 35 includes a shift register 35a. The data signal line driving circuit 36 includes a shift register 36a and a sampling circuit 36b.

The display section 34, the scanning signal line driving circuit 35 and the data signal line driving circuit 36 are monolithically formed on a single substrate. This allows reductions in trouble during manufacturing and in wiring capacitance. In order to realize integration of more pixels and enlarge the display area, the display section 34, the scanning signal line driving circuit 35 and the data signal line driving circuit 36 are realized by a polysilicon thin film transistor formed on a glass substrate, or the like. Additionally, the polysilicon thin film transistor is manufactured at a process temperature of not more than 600° C. so that warp and bends caused by a process made at a temperature of not less than a warp point do not occur even if a normal glass substrate having a warp point of not more than 600° C. is used.

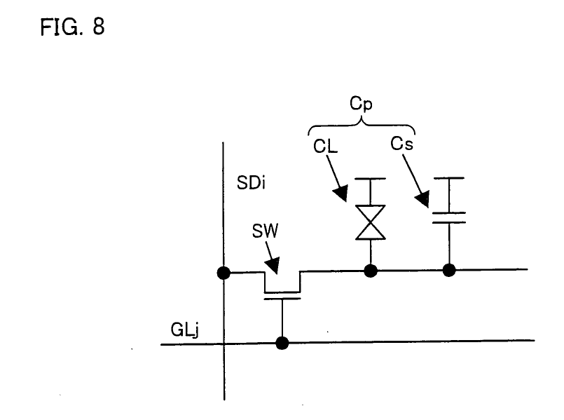

The display section 34 carries out an image display by causing the scanning signal line driving circuit 35 and the data signal line driving circuit 36 to sequentially write a video signal DAT, supplied from the control circuit 37, by use of scanning signal lines GL1 through GLm and data signal lines SD1 through SDk, respectively, into areas of the pixels PIX. The areas of the pixels PIX are formed by dividing the display section 34 into partitions by the scanning signal lines GL1 through GLm and the data signal lines SD1 through SDk, which cross each other. Each of the pixels PIX is arranged, for example, as shown in FIG. 8. In a pixel PIX, (i) an arbitrary integer i, not more than the aforementioned k, and (ii) an arbitrary integer j, not more than the aforementioned m, are added to the scanning signal line GL and the data signal line SD (see FIG. 8). The integers i and j indicate an address.

Each of the pixels PIX includes an electric field effect transistor (switching element) SW and a pixel capacitance Cp. The electric field effect transistor SW has a gate connected to the scanning signal line GL and a source connected to the data signal line SD. The pixel capacitance Cp has one electrode connected to a drain of the electric field effect transistor SW. The other electrode of the pixel capacitance Cp is connected to a common electrode line, which is common to all of the pixels PIX. The image capacitance Cp includes a liquid crystal capacitance CL, and an auxiliary capacitance Cs to be added if necessary.

Therefore, when the scanning signal line GL is selected, the electric field effect transistor SW turns on, and a voltage applied to the data signal line SD is applied to the pixel capacitance Cp. On the other hand, during a period in which a selected period of the scanning signal line GL ends and the electric field effect transistor SW turns off, the pixel capacitance Cp continues to hold a voltage obtained when the electric field effect transistor SW turns off. A transmittance or a reflection rate changes depending on a voltage to be applied to the liquid crystal capacitance CL. Therefore, when selecting a scanning signal line GL and applying a voltage which varies in accordance with a video signal DAT to a data signal line SD, it is possible to change a display state of a pixel PIX in accordance with the video signal DAT.

The video signal DAT for the pixels PIX is transmitted in a time division manner from the control circuit 37 to the data signal line driving circuit 36. The data signal line driving circuit 36 extracts video data for the pixels PIX from the video signal DAT at the timing which is based on a source clock signal SCK, its inverted signal SCKB, a source start pulse SSPi and its inverted signal SSPB, each of which is supplied from a timing signal generation circuit 38, serves as a timing signal, has a duty ratio of 50% (may have a duty ratio equal to or less than 50%), and has a predetermined period. More specifically, the shift register 36a sequentially shifts source start pulses SSP and SSPB in sync with on-timing of source clock signals SCK and SCKB to be supplied. This generates output signals S1 through Sk, which delay respective timing by half a cycle of the source clock signals SCK and SCKB. The sampling circuit 36b carries out a 1st latch with respect to the video signal DAT at the timing indicated by the output signals S1 through Sk. Furthermore, the sampling circuit 36b carries out a 2nd latch with respect to the video signal DAT which has been subjected to the 1st latch, in response to a control signal LP supplied from the control circuit 37 or the timing signal generation circuit 38. Thereafter, the sampling circuit 36b carries out a D/A conversion with respect to the video signal DAT which has been subjected to the 2nd latch. In the sampling circuit 36b, the analog video data DAT thus converted is sampled and supplied to a buffer in response to a sampling signal SMP supplied from the control circuit 37 or the timing signal generation circuit 38, and is then line-sequentially supplied to a respective data signal line SD1 through SDk. As an analog voltage to be supplied to each of the data signal lines SD1 through SDk, a power source voltage to be supplied from the power source circuit 39 to the data signal line driving circuit 36 is used.

Similarly, in the scanning signal line driving circuit 35, the shift register 35a sequentially shifts the gate start pulses GSP and GSPB in sync with the gate clock signals GCK and GCKB to be supplied from the timing signal generation circuit 38. As a result, scanning signals which delay respective timing by a predetermined interval are supplied to the scanning signal lines GL1 through GLm, respectively.

The timing signal generation circuit 38 generates timing signals such as the source clock signals SCK and SCKB, the source start pulses SSP and SSPB, the gate clock signals GCK and GCKB, and gate start pulses GSP and GSPB. Of the timing signals, the gate start pulses GSP and GSPB, as ones of display control signals, particularly is generated so as to be synchronized with a signal HSYNC, which is a horizontal blanking period synchronization signal supplied from the control section 37. The timing signal generation circuit 38 also generates power source signals, for controlling the power source circuit 39, such as a discharge signal DIS, charge signal CHA, and an enable signal EN, in sync with a signal VSYNC, a vertical blanking synchronization signal to be supplied from the control circuit 37, and then supplies the signals to the power source circuit 39. The discharge signal DIS is a control signal causing the inside of a power source to be discharged when the power source circuit 39 is started up. The charge signal CHA is a control signal causing the power source circuit 39 to be charged for preparing its start-up after the power source circuit 39 is discharged in response to the discharge signal DIS. The enable signal EN is a control signal causing a clock signal, used for operating the power source circuit 39 after the power source circuit 39 is charged in response to the charge signal CHA, to be validated. The timing signal generation circuit 38 may also generate source start pulses SSP and SSPB in sync with a dot clock signal.

The control circuit 37 generates signals such as the video signal DAT and the signals VSYNC, HSYNC based on externally supplied control signals and video signals. The control circuit 37 and power source circuit 39 are supplied with power source from a power source section of the liquid crystal display device 31. The power source circuit 39 supplies power source for the scanning signal line driving circuit 35 and common voltage power source for the display section 34, in addition to the power source for supplying the voltages to the data signal lines SD1 through SDk.

The basic arrangement of the liquid crystal display device 31 is as described above.

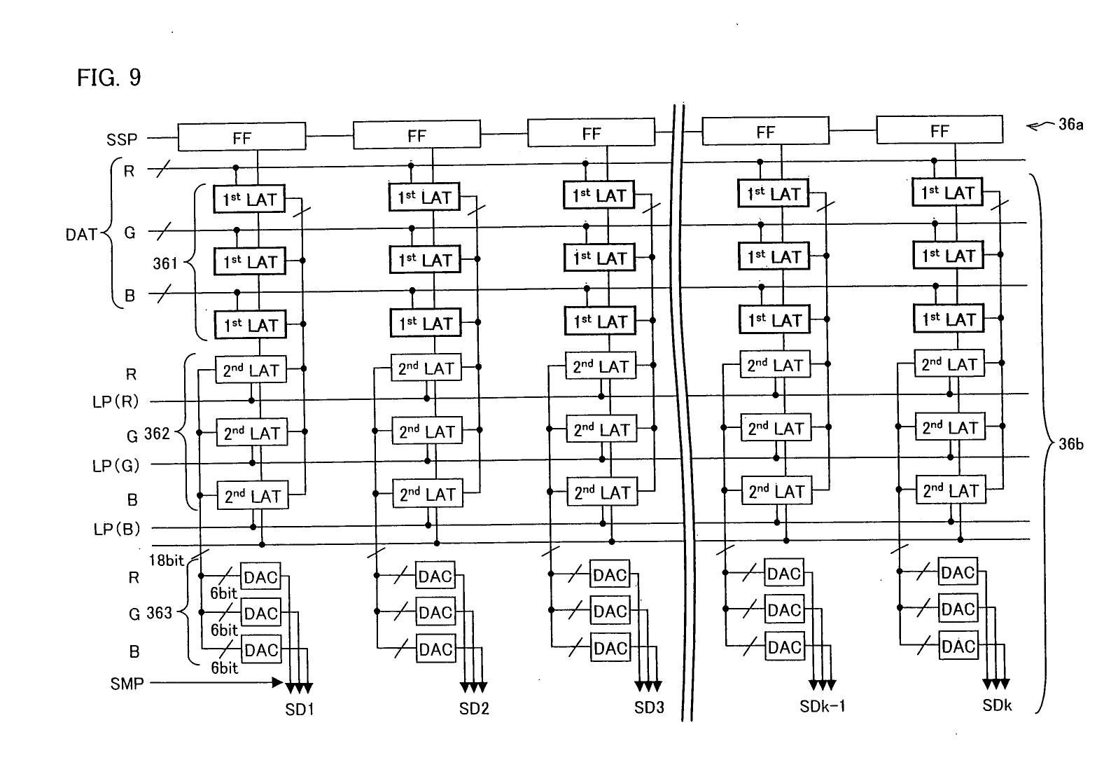

The data signal line driving circuit 36 of the liquid crystal display device 31 is a digital driver, and its circuit configuration is as illustrated in FIG. 9.

A sampling circuit 36b includes a 1st latch circuit 361, a 2nd latch circuit 362 and a D/A conversion section 363. The 1st latch circuit 361 latches video signals DAT for respective RGB in response to sequentially supplied signals from flip-flops FF in a shift register 36a. The 2nd latch 362 latches data supplied from the 1st latch circuit 361 based on timing of control signals LP for the respective RGB. The D/A conversion section 363 (i) carries out, for the respective RGB, D/A conversions with respect to data supplied from the 2nd latch circuit the RGB, (ii) samples the analog data thus converted and temporarily stores them in a buffer (not illustrated) based on the timing of a sampling signal SMP, and then (iii) supplies to data signal lines SD1 through SDk.

The 1st latch circuit 361 has a level shift function. The 2nd latch circuit includes a CMOS circuitry, to which an output voltage of the DC level is supplied from the 1st latch circuit 361. Here, a circuit corresponding to the connection and disconnection section 3 illustrated in FIG. 1 is provided between an output of the 1st latch circuit 361 and the 2nd latch circuit 362.

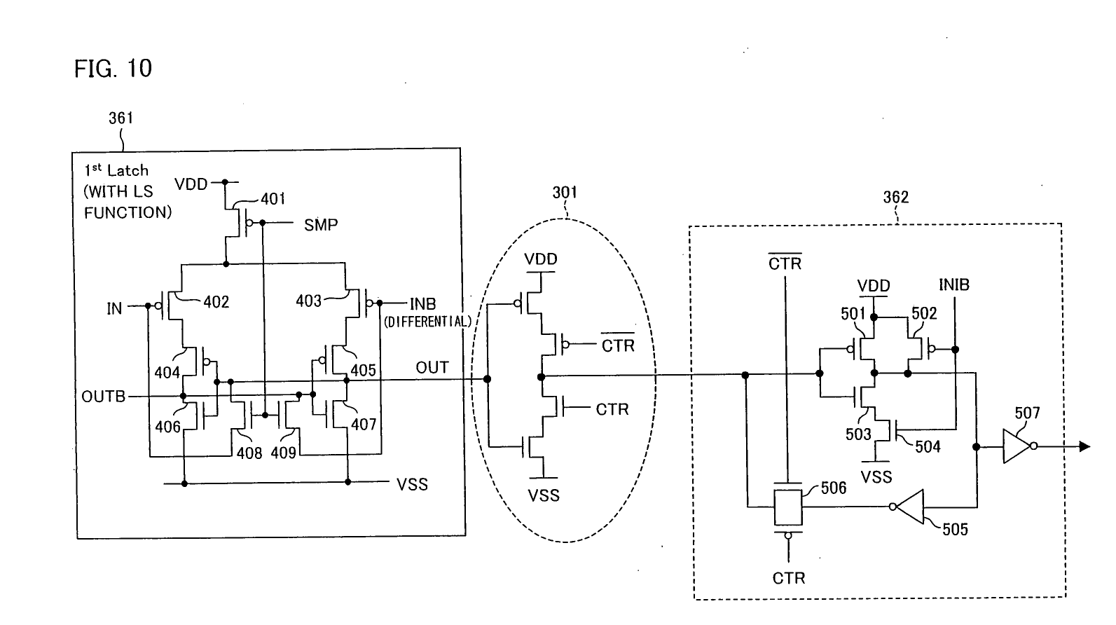

FIG. 10 illustrates a circuit configuration in which a connection and disconnection section 301 is provided between the 1st latch circuit 361 and the 2nd latch circuit 362.

The 1st latch circuit 361 includes p-channel MOS transistors 401 through 405 and n-channel MOS transistors 406 through 409.

A sampling signal SMP is supplied to a gate of the MOS transistor 401 and gates of the MOS transistors 408 and 409. An input signal IN of the 1st latch circuit 361 is supplied to a gate of the MOS transistor 402, and an inverted input signal INB is supplied to a gate of the MOS transistor 403. The input signal IN is a signal which has a voltage of a DC level.

The MOS transistor 401 has a source connected to a power source VDD, and a drain connected to a source of the MOS transistor 402 and a source of the MOS transistor 403. The MOS transistor 402 has a drain connected to a source of the MOS transistor 404. The MOS transistor 404 has a drain connected to a drain of the MOS transistor 406, and via a node point connecting the drains, the 1st latch circuit 361 outputs an inverted output signal OUTB. The MOS transistor 406 has a source connected to a power source VSS. The MOS transistor 403 has a drain connected to a source of the MOS transistor 405. The MOS transistor 405 has a drain connected to a drain of the MOS transistor 407, and via a node point connecting the drains, the 1st latch circuit 361 outputs an output signal OUT. The MOS transistor 407 has a source connected to the power source VSS.

The gate of the MOS transistor 404, the gate of the MOS transistor 406, and the drain of the MOS transistor 408 are connected to a terminal via which an output signal OUT is outputted. The gate of the MOS transistor 405, the gate of the transistor 407, and the drain of the MOS transistor 409 are connected to a terminal via which an inverted output signal OUTB is outputted.

A source of the MOS transistor 408 is connected to an input terminal via which the input signal IN is supplied, and a source of the MOS transistor 409 is connected to an input terminal via which the inverted input signal INB is supplied.

The 1st latch circuit 361 having the above arrangement carries out latching and level shifting when a sampling signal SMP has a Low level (voltage of power source VSS). When the sampling signal SMP has a High level (voltage of power source VDD), the 1st latch circuit 361 passes the input signal IN through to an output of the 1st latch circuit as the output signal OUT, and passes the inverted input signal INB through to another output of the 1st latch circuit as the inverted output signal OUTB.

According to the level shifting carried out when the sampling signal SMP has a Low level, the input signals IN and INB which have an amplitude equal to a difference between the voltage of the power source VSS and the voltage of the power source VCC is stepped up so as to have an amplitude equal to a difference between the power source VSS and a voltage of the power source VDD (voltage of power source VDD>voltage of power source VCC).

The connection and disconnection section 301 is realized by a clocked inverter. As clock signals, a control signal /CTR is supplied to a gate of a p-channel MOS transistor, and a control signal CTR is supplied to a gate of an n-channel MOS transistor, respectively. However, note that the control signal CTR assumingly has logic of FIG. 2.

The 2nd latch circuit 362 includes p-channel MOS transistors 501 and 502, n-channel MOS transistors 503 and 504, inverters 505 and 507, and a CMOS analog switch 506.

The MOS transistors 501 and 502 have sources connected to a power source VDD, and drains connected to a drain of the MOS transistor 503 and each input terminal of the inverters 505 and 507. Gates of the MOS transistor 501 and 503 are connected to an output terminal of the clocked inverter 301 and an output terminal of the analog switch 506. A source of the MOS transistor 503 is connected to a drain of the MOS transistor 504. A source of the MOS transistor 504 is connected to the power source VSS. A signal INIB is supplied to gates of the MOS transistors 502 and 504. The signal INIB becomes a Low level while the 2nd latch circuit 362 is not operated, thereby causing the MOS transistor 502 to turn ON and the MOS transistor 504 to turn OFF. On the other hand, when the 2nd latch circuit 362 is operated, the signal INIB becomes a High level, thereby causing the MOS transistor 502 to turn OFF and the MOS transistor 504 to turn ON. An output terminal of the inverter 505 is connected to an input terminal of the analog switch 506. In the analog switch 506, a control signal /CTR is supplied to a gate of the n-channel MOS transistor, and a control signal CTR is supplied to a gate of the p-channel MOS transistor.

The 2nd latch circuit 362 carries out latching of the data within the circuit while the connection and disconnection section 301 is carrying out a breaking operation. Therefore, input logic is fixed, and so no separate logic inputting means is required.

With the arrangement of FIG. 10, since a voltage for driving a TFT becomes great when a liquid crystal panel is manufactured by use of a polysilicon or a CG silicon, a voltage for driving a TFT in a circuit by which the 1st latch circuit 361 is followed should have a large amplitude of 5 V to 8 V. A signal of around 2 V, which is the same level as a drive power source of an IC using a single-crystal silicon, is supplied to the 1st latch circuit 361. Therefore, the 1st latch circuit 361 carries out a level shift operation, as well as the latch operation. The level shift operation, as described in the problem of the background art, is an amplifying operation which accompanies a large gain. Therefore, it takes a long time for a voltage of the output signal OUT of the 1st latch circuit to rise. However, by providing a connection and disconnection section 301 of the present embodiment, an output voltage of the 1st latch circuit 361 obtained during a rise period will not be supplied to the 2nd latch circuit 362. Therefore, it is difficult for the MOS transistors 501 and 503, which are included in the 2nd latch circuit, to be concurrently turned ON. As a result, it is possible to suppress occurrence of a through current.

The above described the liquid crystal display device 31. It is also possible to use, as the analog amplifier circuit 1, a differential amplifier circuit including a comparator which outputs a DC level, and it is also possible to use a NAND circuit or a NOR circuit as the digital circuit 2. The following description deals with a specific example of the alternatives.

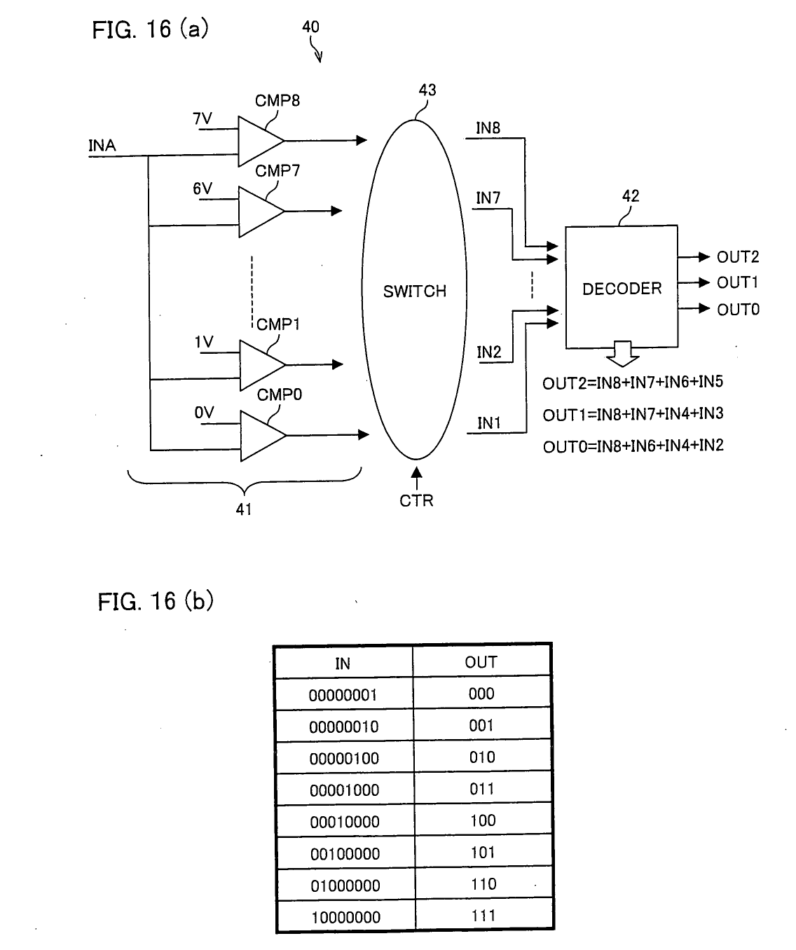

FIG. 16(a) illustrates an A/D converter 40 serving as a circuit for driving a display device, which is used for controlling a backlight of a liquid crystal display device.

The A/D converter 40 converts an output signal supplied from a light sensor into a digital signal. The A/D converter 40 is realized by a flash-type A/D converter, and includes a comparator group 41, a decoder 42, and a switch 43. The comparator group 41 includes comparators CMP0, CMP1, . . . CMP8, each of which compares an input voltage with a respective threshold voltage. Output signals of the comparator group 41 are supplied to the decoder 42 as input signals IN (numerals IN1, IN2, . . . IN8) which constitute a thermometer code. Based on the input signals IN, the decoder 42 generates and outputs bit OUT0, bit OUT1 and bit OUT2 which constitute a 3-bit binary output signal OUT for controlling a backlight. The output signal OUT (bit OUT0, bit OUT1 and bit OUT2) is generated based on operations, shown in FIG. 16(a), using the input signals IN. FIG. 16(b) shows a correspondence table of an 8-bit input signals IN of the decoder 42 and the output signals OUT. NAND circuits and/or NOR circuits are used in an input section of the decoder 42. In the present embodiment, the output signals of the A/D converter 41 are supplied to the NAND circuits and/or the NOR circuits in the input section of the decoder 42, via the switch 43.

In this case, the comparator group 41 (comparators CMP0 through CMP8) corresponds to the analog amplifier circuit 1 shown in FIG. 1, the decoder 42 corresponds to the digital circuit 2 shown in FIG. 1, and the switch 43 corresponds to the connection and disconnection section 3.

This explains the present embodiment. A display device having an arrangement of the present invention is not limited to a liquid crystal display device, and is widely applicable to a display device in which a driving circuit for driving a display device includes (i) a circuit configuration having an analog amplifier circuit which outputs a DC level in accordance with an input signal and (ii) a digital circuit, by which the analog amplifier circuit is followed, having a CMOS circuitry, to which circuit an output voltage is supplied from the analog amplifier circuit. The input signal of the analog amplifier circuit may also be an electric current signal, not just a voltage signal.

A driving circuit of the present invention for a display device may be arranged such that when an input signal is supplied to the analog amplifier circuit, the connection and disconnection means breaks the electrical connection between an output of the analog amplifier circuit and an input of the CMOS circuitry until the output voltage which varies in accordance with the input signal rises or falls, and makes the electrical connection between the output of the analog amplifier circuit and the input of the CMOS circuitry after the output voltage which varies in accordance with the input signal has risen or fallen.

According to the invention, by operating connection and disconnection means as in the aforementioned, it is possible for a CMOS circuitry to receive from the analog amplifier circuit an output voltage, having a DC level, which has risen or fallen. It follows that no output voltage generated during a rise period or a fall period of the analog amplifier circuit 1 is supplied to the CMOS circuitry. Thus, it is possible to attain an effect of suppressing a generation of a through current in the CMOS circuitry.

In the driving circuit for a display device in accordance with the present invention, the connection and disconnection means may be a CMOS analog switch.

According to the invention, it is possible to attain an effect of realizing the connection and disconnection means with ease.

In the driving circuit for a display device in accordance with the present invention, the connection and disconnection means may be a PMOS analog switch.

According to the invention, it is possible to attain an effect of realizing the connection and disconnection means with ease.

In the driving circuit for a display device in accordance with the present invention, the connection and disconnection means may be an NMOS analog switch.

According to the invention, it is possible to attain an effect of realizing the connection and disconnection means with ease.

In the driving circuit for a display device in accordance with the present invention, the connection and disconnection means is a logic circuit to which the output voltage of the analog amplifier circuit is supplied as one input signal; and the logic circuit has a logic configuration so as to (i) output a first logical value corresponding to a value of the output voltage of the analog amplifier circuit while the electrical connection is made, and (ii) output a second logical value which is different from the first logical value.

According to the invention, it is possible to attain an effect of realizing the connection and disconnection means with ease. It is also possible to supply a fixed logic to the CMOS circuitry, even while the connection and disconnection means is breaking the electrical connection between the output of the analog amplifier circuit and the input of the CMOS circuitry.

In the driving circuit for a display device in accordance with the present invention, the logic circuit includes a two-input NAND circuit, which receives (i) the output voltage of the analog amplifier circuit, and (ii) a signal indicating whether to carry out making or breaking the electrical connection; and an output signal of the two-input NAND circuit or a logically-inverted signal of the output signal of the two-signal NAND circuit is supplied as an input signal to the digital circuit.

According to the invention, it is possible to attain an effect of realizing a logic circuit as the connection and disconnection means with ease.

In the driving circuit for a display device with accordance to the present invention, the connection and disconnection means is a logic circuit to which the output voltage of the analog amplifier circuit is supplied as one input; and the logic circuit has a logic configuration so as to (i) output a logical value having a value corresponding to the output voltage of the analog amplifier circuit while the electrical connection is made, and (ii) block an output while the electrical connection is broken.

According to the invention, it is possible to attain an effect of realizing the connection and disconnection means with ease.

In the driving circuit for a display device with accordance to the present invention, the logical circuit is a clocked inverter to which (i) the output voltage of the analog amplifier circuit is supplied as an input and (ii) a signal indicating whether to carry out making or breaking the connection is supplied as a clock input.

According to the invention, it is possible to attain an effect of realizing a logic circuit as the connection and disconnection means with ease.

The driving circuit of the present invention for a display device may further include logic input means for inputting a predetermined logic to the CMOS circuitry while the connection and disconnection means carries out breaking of the electrical connection.

According to the invention, a predetermined logic is inputted to a circuit of a CMOS circuit configuration by logic inputting means while the electrical connection between the output of the analog amplifier circuit and an input of the digital circuit is broken by the connection and disconnection means. This avoids indefinite input logic caused by a break of logic input to the circuit of the CMOS circuit configuration.

A data signal line driving circuit of the present invention may be realized by the driving circuit of the display device, wherein display driving of an active matrix type is applied by the driving circuit.

According to the invention, even if a digital circuit is provided, by which the analog amplifier circuit is followed, having a CMOS circuitry, to which circuitry an output voltage is supplied from the analog amplifier circuit in a data signal line driving circuit, it is possible to suppress a through current occurring in the CMOS circuitry.

A display device of the present invention may include the driving circuit for a display device.

According to the invention, since the display device includes the driving circuit for a display device, it is possible to realize a low electric power consuming display device in which generation of a through current is suppressed.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

The present invention is suitably used for liquid crystal display devices.

1. A driving circuit for a display device comprising a circuit configuration including (i) an analog amplifier circuit which outputs a DC level in accordance with an input signal and (ii) a digital circuit, by which the analog amplifier circuit is followed, including a CMOS circuitry, to which circuit an output voltage is supplied from the analog amplifier circuit, said driving circuit using an output signal supplied from the digital circuit in display driving,
said driving circuit, further comprising:
connection and disconnection means for making and breaking an electrical connection between an output of the analog amplifier circuit and an input of the CMOS circuitry.

2. The driving circuit as set forth in claim 1, wherein, when an input signal is supplied to the analog amplifier circuit,
said connection and disconnection means breaks the electrical connection between the output of the analog amplifier circuit and the input of the CMOS circuitry until the output voltage which varies in accordance with the input signal rises or falls, and makes the electrical connection between the output of the analog amplifier circuit and the input of the CMOS circuitry after the output voltage which varies in accordance with the input signal has risen or fallen.

3. The driving circuit as set forth in claim 1, wherein:
said connection and disconnection means is a CMOS analog switch.

4. The driving circuit as set forth in claim, wherein:
said connection and disconnection means is a PMOS analog switch.

5. The driving circuit as set forth in claim 1, wherein:
said connection and disconnection means is an NMOS analog switch.

6. The driving circuit as set forth in claim 1, wherein:
said connection and disconnection means is a logic circuit to which the output voltage of the analog amplifier circuit is supplied as one input signal; and
the logic circuit has a logic configuration so as to (i) output a first logical value corresponding to a value of the output voltage of the analog amplifier circuit while the electrical connection is made, and (ii) output a second logical value which is different from the first logical value.

7. The driving circuit as set forth in claim 6, wherein:
the logic circuit includes a two-input NAND circuit, which receives (i) the output voltage of the analog amplifier circuit, and (ii) a signal indicating whether to carry out making or breaking the electrical connection; and
an output signal of the two-input NAND circuit or a logically-inverted signal of the output signal of the two-input NAND circuit is supplied as an input signal to the digital circuit.

8. The driving circuit as set forth in claim 1, wherein:
said connection and disconnection means is a logic circuit to which the output voltage of the analog amplifier circuit is supplied as one input signal; and
the logic circuit has a logic configuration so as to (i) output a logical value having a value corresponding to the output voltage of the analog amplifier circuit while the electrical connection is made, and (ii) block an output while the electrical connection is broken.

9. The driving circuit as set forth in claim 8, wherein:
the logical circuit is a clocked inverter to which (i) the output voltage of the analog amplifier circuit is supplied as an input and (ii) a signal indicating whether to carry out making or breaking the electrical connection is supplied as a clock input signal.

10. The driving circuit as set forth in claim 1, further comprising:
logic input means for inputting a predetermined logic to the CMOS circuitry while the connection and disconnection means carries out breaking of the electrical connection.

11. A data signal line driving circuit for a display device which is realized by a driving circuit as set forth in claim 1, wherein display driving of an active matrix type is applied to the display device by the driving circuit.

12. A display device comprising:
a driving circuit for a display device as set forth in claim 1.
